(19) United States
(12) Patent Application Publication
(10) Pub. No.: US 2025/0242412 A1
(43) Pub. Date: Jul. 31, 2025

(54) CNC MACHINE, DRIVE AND METHOD FOR MACHINING A WORKPIECE

(71) Applicant: ODeCon engineering GmbH, Kaiserslautern (DE)

(72) Inventor: Oliver SCHULTE, Kaiserslautern (DE)

(73) Assignee: ODeCon engineering GmbH, Kaiserslautern (DE)

(21) Appl. No.: 18/842,547

(22) PCT Filed: Feb. 27, 2023
(86) PCT No.: PCT/EP2023/054816

§ 371 Date: Apr. 10, 2025

(30) Foreign Application Priority Data
Mar. 1, 2022 (DE) 10 2022 104 799.7
Mar. 1, 2022 (DE) 10 2022 104 800.4

(51) Int. Cl. B22F 12/33; B22F 12/00; B22F 12/37; B22F 12/41; B33Y 30/00

(52) U.S. Cl. CPC B22F 12/33; B22F 12/224; B22F 12/226; B22F 12/37; B22F 12/41; B33Y 30/00

(57) ABSTRACT

The disclosure relates to a CNC machine, in particular a machine for additive manufacturing involving laser welding. The CNC machine comprises a workpiece support that can be moved in a plane along an x-axis and a y-axis. At least for movement along the x-axis, the CNC machine comprises two synchronously moving drives and a counterbalance which moves in the opposite direction.

### CROSS-REFERENCE TO RELATED APPLICATION

This application is a national stage application, filed under 35 U.S.C. § 371, of International Patent Application PCT/EP2023/054816, filed on Feb. 27, 2023, which claims the benefit of German Patent Applications DE 10 2022 104 799.7, filed on Mar. 1, 2022, and DE 10 2022 104 800.4, filed on Mar. 1, 2022.

### TECHNICAL FIELD

The disclosure relates to a CNC machine. More particularly, the disclosure relates to a CNC machine which is used for Extreme High-speed Laser Application welding (EHLA). The disclosure furthermore relates to a method for processing a workpiece, in particular for producing additively created structures on a workpiece.

### BACKGROUND

Unlike selective laser melting, Extreme High-speed Laser Application welding (EHLA) does not involve selective melting of particles in a bath. Rather, the EHLA process uses a nozzle which has a central laser passage. The powder to be processed is fed through inclined passages in the nozzle or through an annular passage in such a way that the emerging powder intersects with the laser beam. The powder is thereby heated up to just below its melting point. At the same time, the laser melts the surface of the workpiece, onto which the powder is incident and is thereby welded to the surface. Above all, this process has the advantage of allowing for very high feed rates which can be in the range of several 100 m/min with a layer thickness of 25 μm.

This means that the surface of the workpiece is only heated to a shallow depth, which reduces thermally induced stresses in the material.

The EHLA process even permits to process metals that would otherwise not be weldable. It allows for low layer thicknesses, gas-tight material application, and an amorphous crystal structure.

In addition to the coating of workpieces, the EHLA process is therefore also suitable for the additive manufacturing of three-dimensional structures. A particular advantage here is that, in contrast to selective laser melting, hardly any powder residues are produced that need to be disposed of or processed.

A problem with the EHLA process, especially when it is used as an additive manufacturing process, is that due to the low layer thickness, high feed rates are necessary to produce components at an appropriate speed.

However, as mentioned above, the EHLA process has the advantage that it is suitable for very high feed rates. An issue here is, however, that the high feed rates also cause correspondingly high accelerations when changing the direction of movement of the workpiece to be manufactured or of the CNC machine used, at least when manufacturing non-rotationally symmetrical bodies.

Published patent application WO 2019/243418 A1 (inventor Oliver Schulte) discloses a CNC machine that comprises three columns which allow to move a workpiece along three axes. Such a CNC machine permits to achieve speeds of at least 200 m/min and maximum accelerations of up to 50 m/s².

### SUMMARY

This application provides a CNC machine, in particular to be used for the EHLA process, which exhibits improved kinematics, and which provides for high feed rates and high accelerations, and/or which allows to integrate additional processing heads for hybrid component manufacturing.

This is achieved by a CNC machine and by a method for processing a workpiece as described and claimed.

According to a first aspect, a CNC machine is designed for additive manufacturing involving laser welding, which comprises a workpiece support that can be moved in a plane along an x-axis and a y-axis, with the CNC machine comprising at least one drive for movement along the x-axis, which drive is arranged on a carriage which in turn can be moved via a gantry drive for movement along the y-axis, wherein the drive for movement along the x-axis comprises a counterbalance moving in the opposite direction to the drive, and wherein the carriage has a drive arranged thereon, which is operable to rotate the workpiece support about an a-axis that is perpendicular to an x-y-plane, and wherein the carriage can be rotated by at least 90° about a c-axis that is lying in or parallel to the x-y-plane.

According to a further aspect, a method for additive manufacturing involves laser welding, in particular using a CNC machine as described above, wherein the workpiece is moved relative to a processing tool at least in an x-direction by a drive for an x-axis; wherein prior to and/or during a necessary change of direction, the movement in the x-direction is at least partially substituted by a combination of a rotation about an a-axis that is perpendicular to an x-y-plane and a linear movement, i.e. translation, in the y-direction.

According to a further aspect, a CNC machine, i.e. a machine tool, uses control technology to manufacture workpieces with high precision and in particular is also capable of producing complex shapes.

The CNC machine is in particular intended for an additive processing tool, in particular for a processing head for an EHLA process. However, within the scope of the invention, the CNC machine may also be used for subtractive processes, in particular involving a laser.

The CNC machine comprises a workpiece support that can be moved in a plane along an x-axis and a y-axis. The x-y-plane can in particular be a horizontally aligned plane.

Thus, the workpiece support can be translated in an x-direction and can be translated in a y-direction. So, an x-y-plane is defined, in which the workpiece support can be displaced.

For movement along the x-axis, the CNC machine comprises at least one drive. This may in particular come in the form of a linear motor.

According to one embodiment, the CNC machine comprises a pair of synchronously moving drives, at least for movement along the x-axis.

These drives will move synchronously in the one direction during displacement. The CNC machine furthermore comprises at least one counterbalance that moves in the opposite direction to the drive for movement in the x-direction.

The counterbalance for the x-axis moves in the opposite direction to the workpiece support.

The CNC machine may also comprise a counterbalance for the movement in the y-direction. The counterbalance for the y-axis moves at an angle of 90° relative to the x-axis, opposite to the movement of the y-axis in the y-direction.

In this way, acceleration and deceleration forces are at least partially canceled out, thus enabling high accelerations and speeds with low vibration.

According to one embodiment, the at least one counterbalance for the x-axis and/or for the y-axis has a mass that corresponds to that of the workpiece support plus the components of the drive coupled to the workpiece support +/−70%, preferably +/−50%.

According to a preferred embodiment, the CNC machine comprises two counterbalances. One for the x-axis as a counterpart to the workpiece support and product. The other one for the y-axis with a counterweight equal to the weight of the entire x-axis, optionally including the rotation axis a of the workpiece support (described below).

The CNC machine in particular comprises a fast x-axis. It preferably allows to accelerate the workpiece support with at least 50 m/s², in particular with 50-200 m/s². Feed speeds of at least 100 m/min, in particular of 100 to 400 m/min, are possible.

The synchronously moving drives may in particular be linear motors.

More particularly, it is intended to use linear motors in which the respective secondary part is moved. The secondary part comprises the one or more permanent magnet(s) and is directly coupled to the workpiece support, in particular via a plate and/or an inner housing, or indirectly via power transmission components.

The secondary part may in particular be coupled to the workpiece support via at least one belt.

The secondary part and thus the workpiece support can be moved via a primary part in the form of a long stator.

The long stator may be divided into segments. Thus, if movement is not required over the entire length of the axis, at least one segment can be switched off. This provides for energy-saving operation.

The synchronous movement of the drives can in particular be provided by a traction drive mechanism.

The traction drive mechanism may, for example, come in the form of least one belt, in particular a toothed belt, and/or a circulating conveyor belt.

The linear motors each act on one side of the traction drive mechanism, and the counterbalance on an opposite side, especially at the top and bottom, respectively.

Thus, the side of the traction means opposite the workpiece support serves as a counterbalance for the workpiece support, whereby forces from acceleration and/or deceleration processes are at least partially canceled out by masses moving in opposite directions.

In one refinement, the drives are enclosed by a conveyor belt that moves with the workpiece support. This may in particular be a metal belt, in particular made of spring steel.

The conveyor belt can serve as a traction means or as part of a traction means and at the same time as an enclosure for at least the components of the x-axis drive and/or y-axis drive.

In particular, the conveyor belt may run on one, preferably two belts, in particular toothed belts.

In one refinement, the workpiece support can be rotated about an a-axis that is perpendicular to the x-y-plane.

The workpiece support may in particular be in the form of a turntable.

The drive used for this purpose may in particular be arranged between the synchronously moving drives. In particular, the drive may be arranged inside the traction means, e.g. in an inner housing which can be moved in the x-direction.

Preferably, this drive for what is referred to as the a-axis is a torque drive. A torque drive likewise allows to achieve very high accelerations and hence high speeds.

The synchronously moving drives may form part of a carriage and the carriage in turn can be moved via a drive for the y-axis.

In particular, it is intended that the core of the CNC machine is defined by a carriage comprising a traction drive mechanism, which comprises a drive for the x-axis.

The carriage may also include the drive for the a-axis.

The carriage itself, in turn, may be coupled to a drive for the y-axis, preferably on two opposite sides, for example via an arm.

During displacement along the y-axis, the entire carriage will thus move in the y-direction.

In this way, the drive for the y-axis only allows to achieve lower accelerations and speeds than the drive for the x-axis.

The y-axis has to move larger loads than the x-axis. Alone its own weight is significantly higher. The advantage of a gantry system for the y-axis comprising a pair of drive trains is the higher system performance. However, energy consumption is many times higher than for the x-axis. For this reason, the x-axis should mainly provide for fast movements of the workpiece.

The additional a-axis allows the workpiece support to be controlled in such a way that processing can be performed predominantly through movement on the x-axis.

The y-drive may in particular be a gantry drive. The opposing y-drives can in particular come in the form of linear motors, preferably with a moving secondary part.

A z-axis is provided by the fact that a support for a processing tool, in particular a laser, can be moved along a z-axis that is perpendicular to the x-y plane. The z-axis can in particular be aligned vertically.

The z-axis is used, for example, to gradually raise the laser when a workpiece is manufactured layer by layer using an additive process. The accelerations and speeds occurring along the z-axis are therefore lower than along the other axes of the CNC machine described above.

In terms of hybrid processing, further processing heads can be mounted either on a positionable carriage together with the first processing head or on independently movable carriages. These may in particular comprise a processing tool with a welding head, a cutting head, and/or a polishing head. The carriages with the processing heads mounted thereon are motorized or are manually adjustable, they can preferably be moved parallel to the x-axis and can be locked in a fixed working position.

It is also possible to synchronously integrate motorized carriages and the processing heads mounted thereon in the processing of a workpiece on the travel path parallel to the x-axis.

This allows to add up the speeds in x-direction in the case of movements in opposite directions. The speed is increased, which is particularly advantageous when processing large workpieces.

Moreover, it is possible to place a plurality of processing heads at different working positions to enable different work steps to be carried out simply by moving the x-carriage to the respective working position. This can result in significant reductions in throughput times, particularly in the manufacture of series parts.

According to a further aspect, the disclosure relates to a CNC machine, in particular one having one or more of the features described above.

The CNC machine comprises a workpiece support which can be moved on a carriage along an x-axis and a y-axis, with the y-movement being produced by a movement of the carriage itself. The workpiece support is rotatable about an a-axis that is perpendicular to an x-y-plane.

The additional a-axis makes it possible to rotate the workpiece while it is being moved along the x-axis. The x-axis, which is faster than the other axes, can therefore be used preferentially, for example to weld on a particle track.

However, it is also possible to at least partially substitute a movement in the x-direction by a rotation about the a-axis superimposed with a movement along the y-axis.

A distinction is made between a movement in the x-direction or y-direction and a movement along the x-axis or y-axis. Thus, the x-drive always moves in the x-direction, and the y-drive always moves in the y-direction.

However, a movement of the workpiece in the x-direction is also possible by rotating the workpiece support about the a-axis and compensating for the circular path that would normally result therefrom by an appropriately controlled movement of the drive for the y-axis.

The movement in x-direction via the a-axis and the y-axis makes it possible to accelerate or decelerate the drive for the x-axis during this substitute movement without changing the feed rate.

For example, the x-drive can be slowed down before reaching a point where a change in the direction of movement is required.

The drive for the a-axis benefits from the fact that, in particular provided it is integrated in the carriage for the x-axis, it has to move the smallest mass compared to the other drives (with the exception of the drive for the z-axis). In particular when in the form of a torque drive, the drive for the a-axis can achieve high accelerations and speeds.

The disclosure furthermore relates to a drive, in particular for the CNC machine as described above.

The drive comprises a carriage on which a workpiece support can be moved linearly along an x-axis. The carriage is enclosed by a conveyor belt that moves together with the workpiece support and preferably serves as a traction means.

Furthermore, the carriage comprises a drive arranged therein for rotating the workpiece support about an a-axis.

The drive can furthermore in particular be designed as described above with reference to the CNC machine.

The disclosure further relates to a method for processing a workpiece.

The disclosure in particular relates to a method in which the CNC machine as described above is used.

The workpiece is in particular processed involving a laser application welding process.

This involves moving the workpiece using a drive for an x-axis at least in an x-direction relative to a processing tool, in particular a laser.

Prior to and/or during a necessary change of direction, the movement in the x-direction by the drive for the x-axis is at least partially substituted by a combination of a rotation about an a-axis perpendicular to a y-x-plane and a linear movement in the y-direction.

During this substitute movement, the x-drive can be accelerated or decelerated, preferably without thereby changing the feed rate.

The x-axis, which is faster than the other axes, can thus be used preferentially to achieve the desired feed rate.

According to one embodiment of the method, it is in particular possible for the processing tool to process the workpiece even when the direction of movement is changed, in particular by at least 30°, preferably by 90°.

However, it is also possible for the workpiece to move past the processing tool, in particular in the event of abrupt changes in the direction of movement.

For example, the laser can be temporarily switched off, and the drive, in particular that for the x-axis, can be slowed down and accelerated in the opposite direction. The laser is then switched on again when the workpiece returns to the processing zone, optionally brought into the correct orientation by the drive for the a-axis.

The disclosure also relates to a CNC machine, in particular one with the features as described above.

The CNC machine comprises a workpiece support that can be moved along an x-axis and a y-axis in an x-y-plane, and the workpiece support can be swiveled about a c-axis that lies parallel to the x-y-plane, in particular in the x-y-plane.

More particularly, the workpiece support can be swiveled through 180°, and a further workpiece support is arranged on a side opposite the workpiece support.

Thus, the CNC machine in particular has a swivel axis c, which allows to rotate the x-axis together with the a-axis mounted on the carriage, i.e. the x-a-drive, about a rotation axis that is parallel to the direction of travel of the x-axis. Preferably, swivel angles of at least +/−90°, in particular from +185° to −185°, are possible.

The c-axis permits the workpiece to be turned on its side and processed on the side.

The c-axis may be implemented by swivel bearings for the connecting pieces between the x-a-axis and the carriages of the y-axes, and by rotary motors, preferably torque motors, on at least one side of the x-a-axis.

The entire x-a-drive can be turned upside down, so to speak.

Rotation about the c-axis by 180° allows, for example, for a carriage plate of the x-a-drive, which serves as a counterweight, to be turned into the processing position and thus provide for a second processing platform.

Moreover, the c-axis may also be integrated into the movement sequence when processing a workpiece. For example, depending on the processing point, the distance between the head of the processing tool and the workpiece may also be changed via the c-axis.

### BRIEF DESCRIPTION OF THE DRAWINGS

The subject-matter of the invention will now be explained in more detail by way of an exemplary embodiment with reference to the drawings of FIGS. 1 through 12.

FIG. 1 is a perspective view of an exemplary embodiment of a CNC machine.

FIG. 2 shows the CNC machine with the housing removed.

FIGS. 3 to 5 are perspective views of the drive components for the y-axis.

FIG. 6 shows the drive for the x-axis and a-axis in the form of a carriage.

FIGS. 7 and 8 are perspective views of the x-a-drive without the conveyor belt and the side walls.

FIG. 9 is a cross-sectional view through the center of the x-a-drive.

FIGS. 10 to 12 are schematic diagrams which are referred to for explaining the steps of the method according to the disclosure.

### DETAILED DESCRIPTION

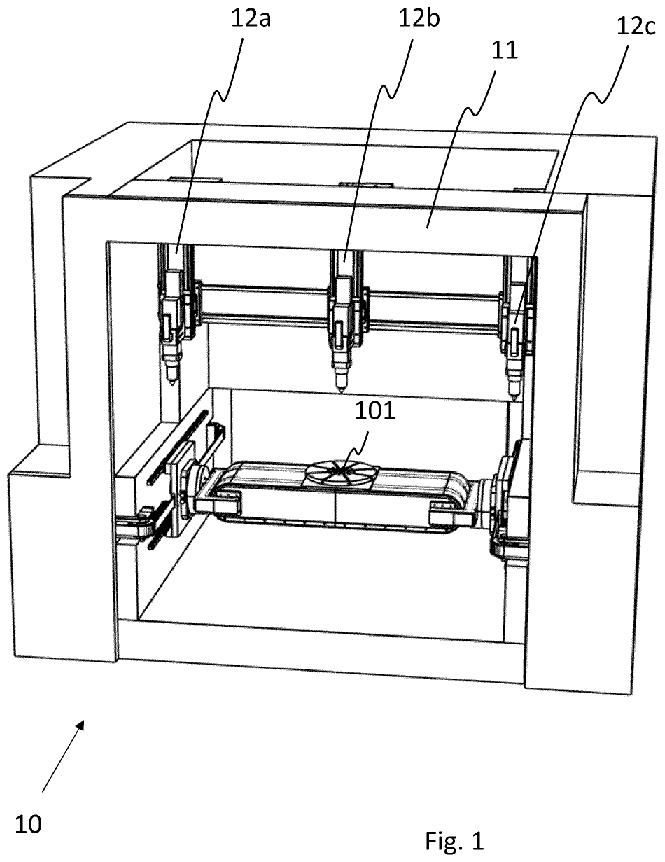

FIG. 1 is a perspective view of a CNC machine 10 according to one exemplary embodiment.

The CNC machine 10 comprises a housing 11. The housing 11 may, for example, provide for extraction, an inert gas atmosphere, and/or explosion protection.

The CNC machine 10 comprises a workpiece support 101 which is displaced by the CNC machine 10 relative to a processing tool 12b.

In this view, a total of three processing tools 12a-12c are provided. The processing tools 12a-12c may, for example, comprise a laser and a particle feed for laser application welding.

The provision of a plurality of processing tools 12a-12c enables versatile use of the CNC machine 10. In particular, the various processing tools 12a-12c can be employed, for example, to additively apply different materials to a workpiece.

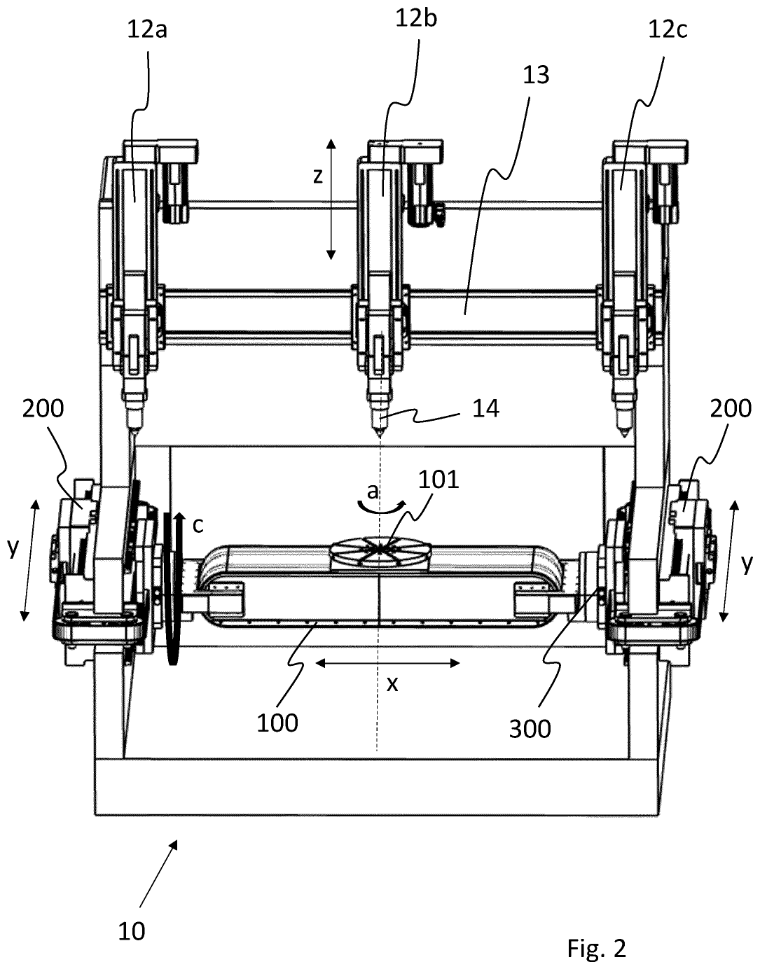

FIG. 2 shows the CNC machine 10, now with the housing removed.

The different axes of movement are indicated.

The CNC machine 10 comprises an x-a-drive 100 as a central component. The x-a-drive 100 comes in the form of a carriage on which the workpiece support 101 is arranged.

The carriage per se allows to move the workpiece support 101 in the x-direction.

Furthermore, the workpiece support 101 can be rotated about the vertically aligned a-axis.

Movement in the y-direction is enabled by the y-drive 200, which comes in the form of a gantry drive.

In the present exemplary embodiment, the x-y-plane is a horizontal plane.

The y-drive 200 displaces the entire x-a-drive 100, which comes in the form of a carriage, in the y-direction.

A movement of the workpiece relative to the processing tool 12a-12c along the z-axis is provided by the fact that the processing tools 12a-12c can be moved linearly, i.e. translated, along the z-axis.

Furthermore, a plurality of processing tools 12a-12c are arranged on a rail 13 in a displaceable manner, so that they can be used alternatively by the CNC machine 10 without need for replacement by another tool.

Furthermore, the y-drive 200 is coupled to the x-a-drive 100 via a c-drive 300.

The c-drive allows to swivel the x-a-drive, in particular to turn it over so that the workpiece support 101 faces downwards.

On the side of the x-a-drive 100 opposite the workpiece support 101, a further workpiece support may be provided. This further workpiece support may serve as a counterbalance.

Moreover, the c-axis can also be used to control the movement of the workpiece relative to the respective processing tool 12a-12c.

Thus, the workpiece support 101 can be translated, i.e. moved linearly, relative to the processing tool 12b along the x-axis, y-axis, and z-axis.

The a-axis is an axis of rotation, preferably about a central axis of the workpiece support 101.

The c-axis is a swivel axis that lies parallel to the x-y-plane. In the present exemplary embodiment, the c-axis extends parallel to the x-axis and perpendicular to the y-axis.

The x-a-drive can be rotated through 180° about the c-axis.

In the present exemplary embodiment, the processing tools 12a-12c comprise a laser nozzle 14 which allows to apply a powder to the workpiece, in particular a metal powder, by laser application welding.

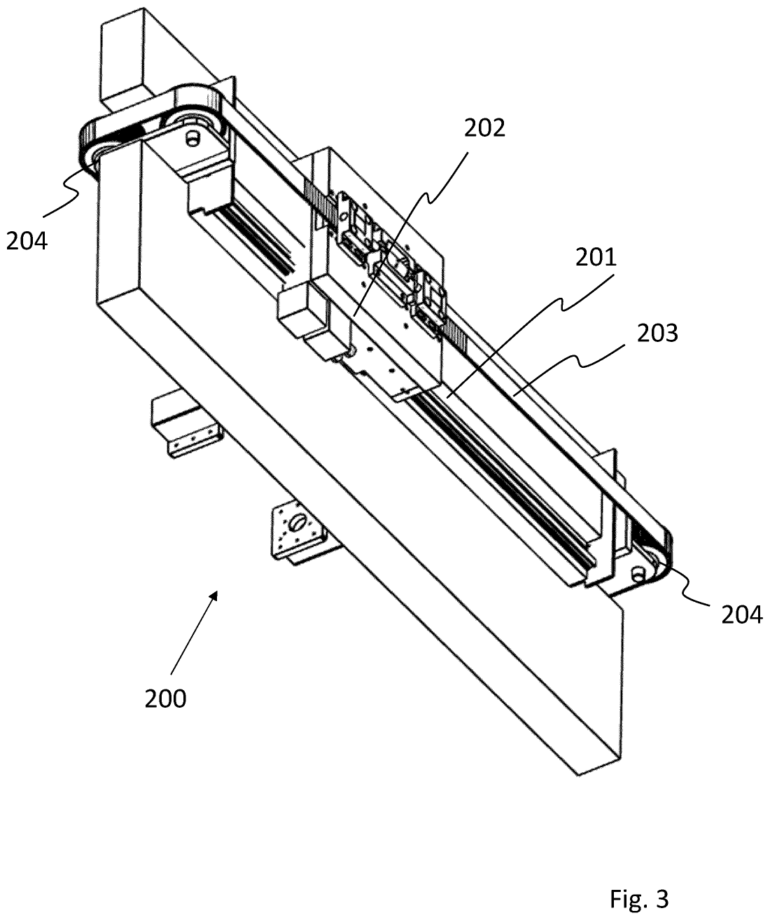

FIG. 3 is a perspective view of one side of the y-drive 200, namely from the right side in FIG. 2.

The y-drive 200 comes in the form of a linear motor. It comprises the primary part 201. The secondary part 202 which is moved over the primary part 201, is coupled to a belt 203.

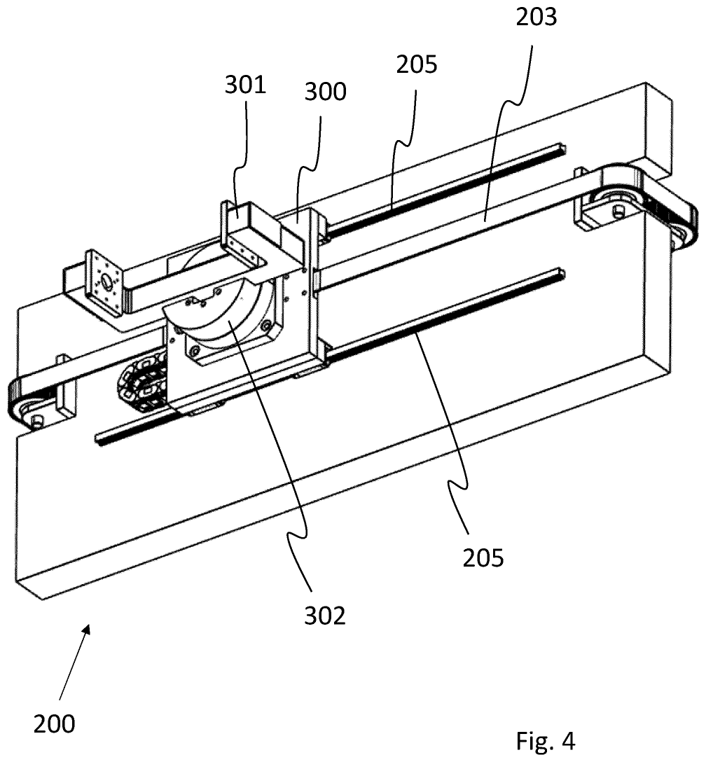

The belt 203 is coupled to the c-drive 300 as shown in FIG. 4 via pulleys 204.

FIG. 4 shows the side opposite to that in FIG. 3 of the y-drive 200.

Thus, the secondary part 202 and the c-drive 300 as well as the components coupled to c-drive 300 will therefore move in opposite directions when the y-drive moves.

The c-drive and the carriage coupled to the c-drive and comprising the ax-drive will therefore move in opposite directions due to the coupling by virtue of belt 203. The acceleration forces which are at least partially canceled out in this way reduce the vibrations caused by the c-drive.

The c-drive 300 comes in the form of a carriage which runs in the rails 205 and which is moved by the belt 203. This provides a movement along the y-axis. The carriage of the c-drive moves in the opposite direction to the secondary part of the y-drive (202 in FIG. 3).

The c-drive 300 in the form of a carriage has a swivel drive 302 provided thereon, which is operable to swivel a connecting arm 301 in order to turn around the x-a-drive. In this exemplary embodiment, the drive for the c-axis constitutes a support and at the same time a drive.

The swivel drive 302 does not need to reach elevated speeds. Swivel drive 302 can therefore be in the form of an electric motor with a gear, for example, or a torque motor or other direct drive.

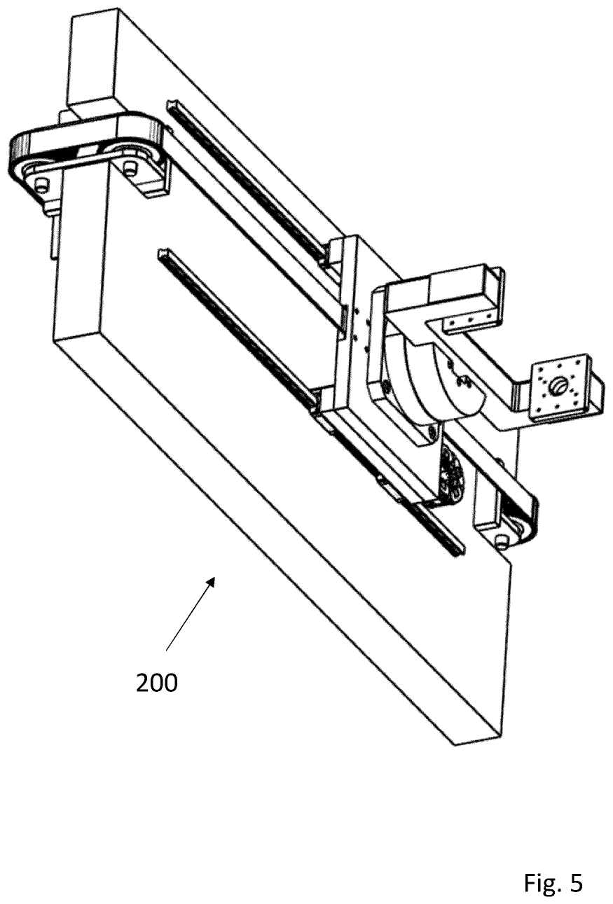

FIG. 5 is a perspective view of the y-drive 200 on the left side of FIG. 2. It is designed as a mirror image of the drive according to FIG. 4.

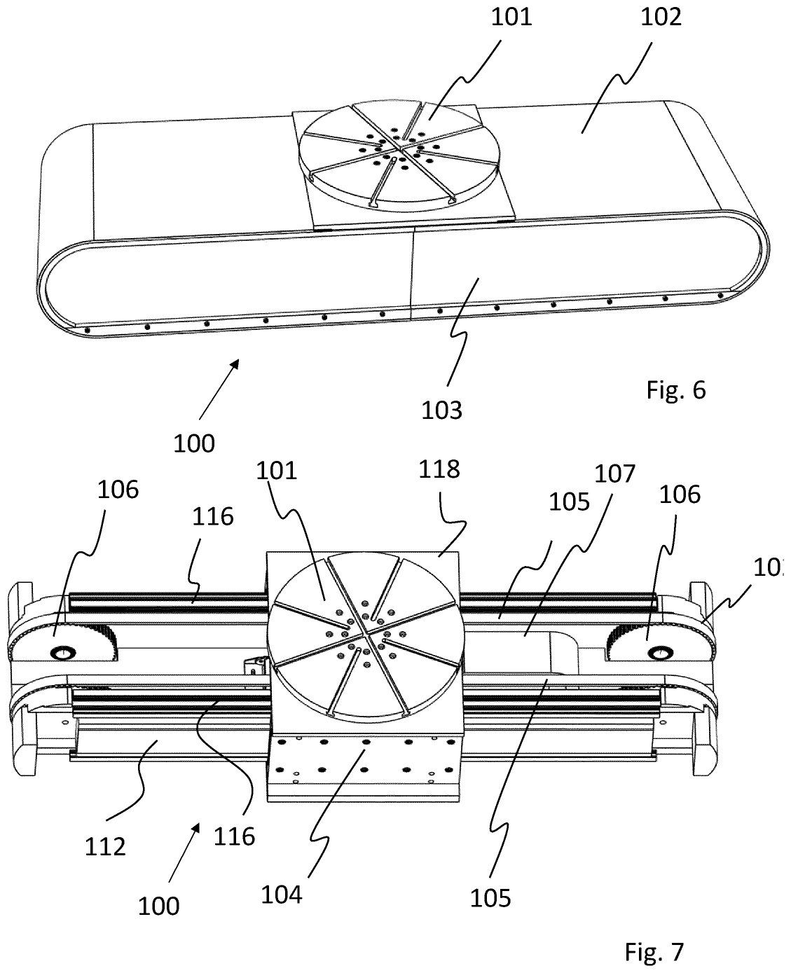

FIG. 6 is a perspective view of the x-a-drive 100. The x-a-drive 100 comes in the form of a carriage and comprises the workpiece support 101 on an upper side.

The carriage is defined by side walls 103 and a circulating conveyor belt 102. The circulating conveyor belt 102 and the side walls 103 define a substantially closed housing inside of which the a-drive for the workpiece support 101 is accommodated. Between circulating conveyor belt 102 and side walls 103, a seal may be arranged, for example a felt seal (not shown).

The circulating conveyor belt 102 moves with the workpiece support 101 in the x-direction.

FIG. 7 shows the x-a-drive 100 in a perspective view without the belt and the side walls.

The x-a-drive comprises linear motors including the secondary parts 104 which are arranged opposite each other on either side of the carriage.

The secondary parts 104 move synchronously.

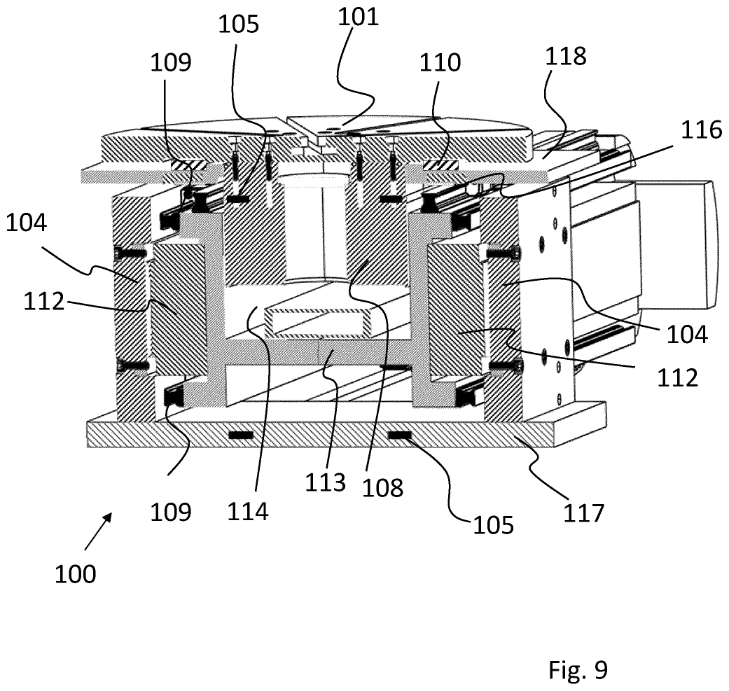

A plate 118 with the rotatable workpiece support 101 is coupled to the secondary parts. Plate 118 forms part of an inner housing (113 in FIG. 9), which is displaced on rails 116 in x-direction.

Furthermore, the workpiece support is connected to two belts 105 which run parallel to each other over rollers 106. The rollers 106 may be in the form of gear wheels. The rollers 106 may have a respective belt 105 running thereon, which belt in turn guides the conveyor belt (102 in FIG. 6). The belts 105 may come in the form of toothed belts.

The primary parts 112 for the x-drive are each in the form of a long stator and each extend from roller 106 to roller 106.

The torque drive for the a-axis is arranged between the secondary parts 104 of the linear motors. A cable harness 107 for the torque drive also extends between the two linear motors.

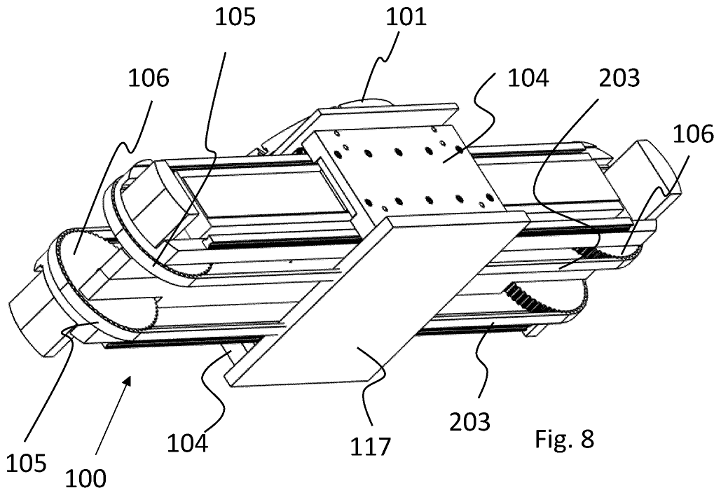

FIG. 8 is another perspective view of the x-a-drive 100.

The belts 105 serve as traction means and extend around the rollers 106.

A counterbalance 117 is provided on the side opposite the workpiece support 101.

The counterbalance 117 is coupled to the belts 105.

When the workpiece support 101 is displaced in x-direction along with the secondary parts 104, the counterbalance 117 will move in the opposite direction so as to serve as a counterweight. Since it is possible to turn the carriage through 180° about the c-axis, the counterbalance may also comprise functional components, such as another workpiece support (not shown).

FIG. 9 is a cross-sectional view through the center of the x-a-drive 100.

The two linear motors of the drive, each comprising a secondary part 104 and a primary part 112, are arranged on the lateral sides.

The primary part 112 is in the form of a long stator. The primary part 112 is mounted to the outer surface of an inner housing 113.

Each of the secondary parts 104 is coupled to plate 118 on which the workpiece support 101 is arranged.

The secondary parts 104 are guided on the rails 109. The secondary parts are coupled to the inner housing which is guided on the rails 116 via plate 118. In the cross-sectional view, rails 116 and 119 are aligned perpendicular to each other. The remaining degree of freedom for the inner housing 113 together with secondary parts 114 and the workpiece support 101 as well as the a-drive is the x-axis which is aligned perpendicular to the cross-sectional plane.

The inner housing 113 defines a space 114 which is used to accommodate the torque drive 108 for the a-axis.

The torque drive 108 is operable to move the workpiece support 101 about its central axis. For this purpose, bearing 110 is in the form of a rotary bearing. When the workpiece support 101 is moved, the torque drive 108 inside the inner housing 113 will move in x-direction.

The counterbalance 117 arranged on the side opposite to the workpiece support 101 is coupled to the belts 105 and moves in the opposite direction to the secondary parts.

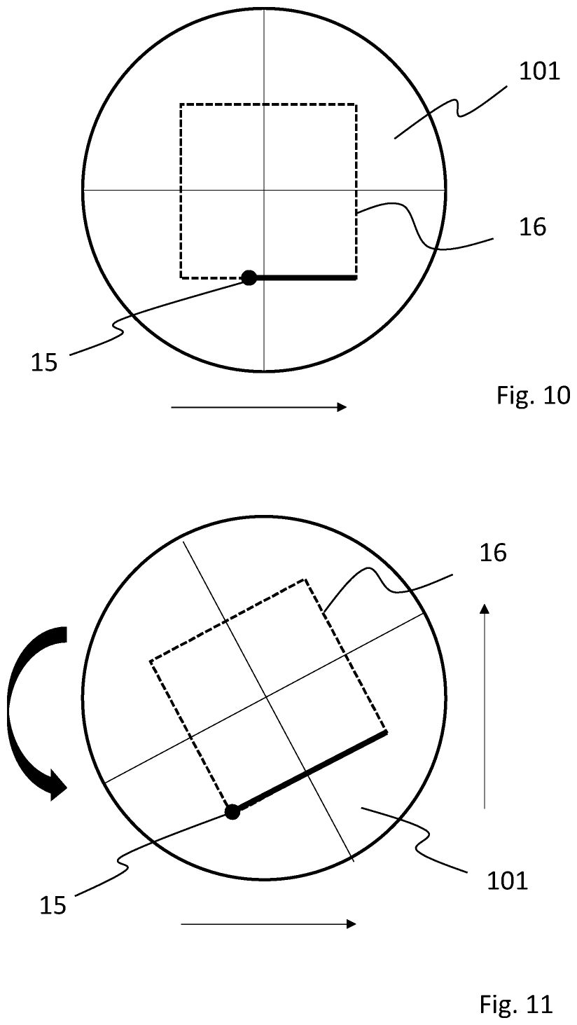

FIGS. 10 to 12 are schematic diagrams for illustrating the method steps according to an exemplary embodiment of the method for additive manufacturing.

What is schematically shown in FIG. 10 is the workpiece support 101 which is moved in x-direction by the x-a-drive.

The working point 15 of a processing tool, such as a tool for laser application welding, will therefore move on the workpiece in the opposite direction relative to the workpiece. In this illustrative example, a square shape 16 is intended to be tracked on the workpiece.

In the case of an exclusive movement via the x-axis and y-axis, the x-drive would have to be stopped when the working point approaches the corner of shape 16, and then movement would have to start in the y-direction.

This would lead to undesirable fluctuations in the feed rate. Furthermore, such an abrupt deceleration from a high feed rate is hardly possible.

Therefore, as illustrated in FIG. 11, the movement of the workpiece and hence the movement of the working point 15 in the x-direction is at least partially substituted by a rotation about the a-axis superimposed with a movement along the y-axis. The movement along the x-axis can now be slowed down.

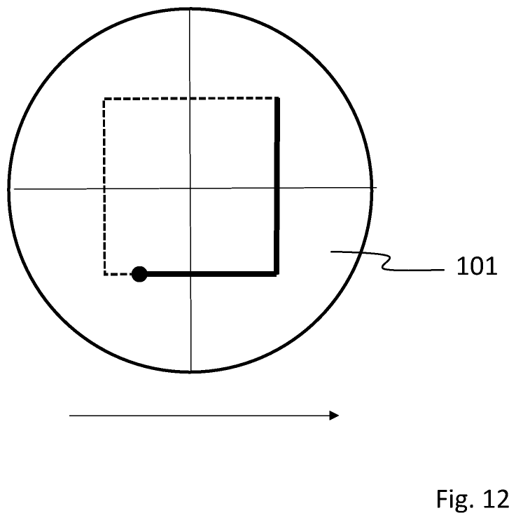

The workpiece is rotated and is then again moved further by the x-drive, as shown in FIG. 12, to complete the next side of the square.

On the one hand, this allows to predominantly use the x-axis, which is faster than the other axes. On the other hand, deceleration and acceleration processes of the x-drive can be slowed down and the feed rate can be made more uniform.

Instead of changing direction at the turning point, it is also possible to switched off the processing tool when leaving the contour of shape 16. The deceleration of the movement in the x-direction and the rotation about the a-axis may be accomplished with the processing tool switched off outside the contour of shape 16.

The disclosure provides a CNC machine that can be used in a versatile manner and which in particular allows for very high feed rates.

### LIST OF REFERENCE NUMERALS

10 CNC machine
11 Housing
12a-12c Processing tool
13 Rail
14 Laser nozzle
15 Working point
16 Shape
100 x-a-drive
101 Workpiece support
102 Conveyor belt
103 Side wall
104 Secondary part
105 Belt
106 Roller
107 Wiring harness
108 Torque drive
109 Guide rail
110 Bearing
112 Primary part
113 Inner housing
114 Space
116 Rail
117 Counterbalance
118 Plate
200 Y-drive
201 Primary part
202 Secondary part
203 Belt
204 Pulley
205 Rail
300 C-drive
301 Connecting arm
302 Swivel drive

1.-27. (canceled)

28. A CNC machine for additive manufacturing by laser welding, comprising:
a workpiece support configured to be moved in an x-y-plane along an x-axis and a y-axis;
a counterbalance configured to move opposite to the workpiece support;
an x-axis drive for moving the workpiece support along the x-axis and moving the counterbalance in opposite direction, the x-axis drive, the workpiece support, and the counterbalance being arranged on a carriage,
an a-axis drive arranged on the carriage and operable to rotate the workpiece support about an a-axis that is perpendicular to the x-y-plane;
a gantry drive for moving the carriage along the y-axis; and
a laser adapted to be moved along a z-axis that is perpendicular to the x-y-plane,
wherein the carriage can be rotated by at least 90° about a c-axis that is lying in or parallel to the x-y-plane.

29. The CNC machine of claim 28,
wherein the carriage can be rotated by at least 180° about the c-axis.

30. The CNC machine of claim 28,
wherein the a-axis drive is a torque drive.

31. The CNC machine of claim 28,
wherein the x-axis drive comprises a pair of synchronous drives.

32. The CNC machine of claim 31,
wherein each drive of the pair of synchronous drives comprises a linear motor including a moving secondary part.

33. The CNC machine of claim 28,
wherein the x-axis drive moves the counterbalance via a traction drive mechanism.

34. The CNC machine of claim 28,
wherein the x-axis drive is enclosed by a conveyor belt that is moving with the workpiece support.

35. The CNC machine of claim 32,
wherein the a-axis drive is arranged below the workpiece support and between the pair of synchronous drives.

36. The CNC machine according to claim 35,
wherein the workpiece support can be swiveled about at least 180°,
wherein a further workpiece support is arranged on a side opposite the workpiece support; and/or
wherein the c-axis is arranged parallel to the x-axis.
